(19) United States
(12) Patent Application Publication
(10) Pub. No.: US 2017/0045979 A1
(43) Pub. Date: Feb. 16, 2017

(54) Touch Panel and Mobile Terminal

(71) Applicants: Shenzhen China Star Optoelectronics Technology Co., Ltd., Shenzhen, Guangdong (CN); Wuhan China Star Optoelectronic Technology Co., Ltd., Wuhan, Hubei (CN)

(72) Inventors: Man LI, Shenzhen, Guangdong (CN); Yao-li HUANG, Shenzhen, Guangdong (CN); Xingling GUO, Shenzhen, Guangdong (CN)

(73) Assignee: Shenzhen China Star Optoelectronics Technology Co., Ltd., Shenzhen, Guangdong (CN)

(21) Appl. No.: 14/646,013

(22) PCT Filed: May 8, 2015
(86) PCT No.: PCT/CN2015/078545

§ 371 Date: May 19, 2015

(30) Foreign Application Priority Data
Apr. 9, 2015 (CN) 201510166244.1

(51) Int. Cl. G06F 3/041; G06F 3/044

(52) U.S. Cl. CPC G06F 3/0416; G06F 3/044; G06F 2203/04103

(57) ABSTRACT

The present invention proposes a touch panel and a mobile terminal. The touch panel includes a first conducting wire extending along a first direction and a second conducting wire extending along a second direction and crossing the first conducting wire. The first conducting wire includes first sensing electrodes arranged along the first direction and first connecting bridges linking two adjacent first sensing electrodes. The second conducting wire includes second sensing electrodes arranged along the second direction and second connecting bridges linking two adjacent second sensing electrodes. Each first sensing electrode comprises one or more pinnacles extending toward a third direction, and each pinnacle overlaps and is spaced apart from the second sensing electrode. Therefore, the accumulated electric charges discarge electricity through the pinnacle, and the second sensing electrode produces a current. real-time discharge of electrostatic is conducted.

### BACKGROUND OF THE INVENTION

1. Field of the Invention

The present invention relates to a touch panel and a mobile terminal.

2. Description of the Prior Art

A touch panel has advantages over a rapid response speed, precise positioning, multi-touch points, and a long life time, and are widely used in a mobile terminal. The touch panel with larger size and more resolution is more convenient for a user. However, a possibility of electrostatic damage in the touch panel increases in the processes of forming the touch panel. Furthermore, accumulated charges caused by rubbing the touch panel may serve as a contact on the touch panel, thereby triggering in fault. Therefore, an electrostatic discharge (ESD) protection circuit is disposed in the touch panel to leak out the accumulated charges rapidly.

Nevertheless, it is difficult to dispose more ESD protection circuits on the touch panel due to crowed electrodes on the touch panel. Recently, utilizing metallic edges surrounding the touch panel and connected to ground is adopted. Please refer to FIG. 1 showing a schematic diagram of a conventional touch panel using the metallic edges connected to ground. Only electrostatic charge near the metallic edges is leaked out, but the accumulated charge in an area away from the metallic edges remains. As a result, such touch panel using the metallic edges still fails to overcome electrostatic interference.

### SUMMARY OF THE INVENTION

The present invention proposes a touch panel and a mobile terminal for solving the issue with ESD on the touch panel in the conventional technology.

According to the present invention, a touch panel comprises a first conducting wire extending along a first direction, comprising a plurality of first sensing electrodes arranged along the first direction and a plurality of first connecting bridges linking two adjacent first sensing electrodes; and a second conducting wire extending along a second direction and crossing the first conducting wire, comprising a plurality of second sensing electrodes arranged along the second direction and a plurality of second connecting bridges linking two adjacent second sensing electrodes. Each first sensing electrode comprises one or more pinnacles extending toward a third direction, and each pinnacle overlaps and is spaced apart from the second sensing electrode. In a top view, the plurality of first sensing electrode and the plurality of second sensing electrode are arranged in a zigzag order, the first connecting bridge overlaps the second connecting bridge. The first direction is perpendicular to the second direction.

Furthermore, each first sensing electrode and each second sensing electrode are shaped as diamonds, and edges of the first sensing electrode are parallel to corresponding edges of the second sensing electrode.

According to the present invention, a touch panel comprises a first conducting wire extending along a first direction, comprising a plurality of first sensing electrodes arranged along the first direction and a plurality of first connecting bridges linking two adjacent first sensing electrodes; and a second conducting wire extending along a second direction and crossing the first conducting wire, comprising a plurality of second sensing electrodes arranged along the second direction and a plurality of second connecting bridges linking two adjacent second sensing electrodes. Each first sensing electrode comprises one or more pinnacles extending toward a third direction, and each pinnacle overlaps and is spaced apart from the second sensing electrode.

Furthermore, in a top view, the plurality of first sensing electrode and the plurality of second sensing electrode are arranged in a zigzag order, the first connecting bridge overlaps the second connecting bridge.

Furthermore, each first sensing electrode and each second sensing electrode are shaped as diamonds, and edges of the first sensing electrode are parallel to corresponding edges of the second sensing electrode.

Furthermore, a length of the pinnacle is longer than an interval between the first sensing electrode and the second sensing electrode.

Furthermore, the touch panel further comprises an insulting layer sandwiched between the plurality of first connecting bridges and the plurality of second connecting bridges.

Furthermore, each first sensing electrode comprises four pinnacles disposed on four edges of the first sensing electrode, respectively.

Furthermore, the first connecting bridge links two vertices of the two adjacent first sensing electrodes, and a distance from the pinnacle to the first connecting bridge linking the first sensing electrode which comprises the pinnacle is less than a distance between the pinnacle and other corners of the first sensing electrode.

Furthermore, the edges of the first sensing electrode and the second sensing electrode are set to 3 mm˜7 mm, and a distance between the pinnacle and the first connecting bridge is 1 mm˜3 mm.

Furthermore, the first direction is perpendicular to the second direction.

According to the present invention, a mobile terminal comprises a touch panel. The touch panel comprises a first conducting wire extending along a first direction, comprising a plurality of first sensing electrodes arranged along the first direction and a plurality of first connecting bridges linking two adjacent first sensing electrodes; and a second conducting wire extending along a second direction and crossing the first conducting wire, comprising a plurality of second sensing electrodes arranged along the second direction and a plurality of second connecting bridges linking two adjacent second sensing electrodes. Each first sensing electrode comprises one or more pinnacles extending toward a third direction, and each pinnacle overlaps and is spaced apart from the second sensing electrode.

Furthermore, in a top view, the plurality of first sensing electrode and the plurality of second sensing electrode are arranged in a zigzag order, the first connecting bridge overlaps the second connecting bridge.

Furthermore, each first sensing electrode and each second sensing electrode are shaped as diamonds, and edges of the first sensing electrode are parallel to corresponding edges of the second sensing electrode.

Furthermore, a length of the pinnacle is longer than an interval between the first sensing electrode and the second sensing electrode.

Furthermore, the touch panel further comprises an insulting layer sandwished between the plurality of first connecting bridges and the plurality of second connecting bridges.

Furthermore, each first sensing electrode comprises four pinnacles disposed on four edges of the first sensing electrode, respectively.

Furthermore, the first connecting bridge links two vertices of the two adjacent first sensing electrodes, and a distance from the pinnacle to the first connecting bridge linking the first sensing electrode which comprises the pinnacle is less than a distance between the pinnacle and other corners of the first sensing electrode.

Furthermore, the edges of the first sensing electrode and the second sensing electrode are set to 3 mm˜7 mm, and a distance between the pinnacle and the first connecting bridge is 1 mm˜3 mm.

Furthermore, the first direction is perpendicular to the second direction.

In contrast to prior art, the touch panel of the present invention comprises a first conductive wire extending along a first direction and a second first conductive wire extending along a second direction. The first and second conductive wires are overlapped. The first conductive wire comprises a plurality of first sensing electrodes arranged at intervals and a first connecting bridge connecting any two adjacent first sensing electrodes. The second conductive wire comprises a plurality of second sensing electrodes arranged at intervals and a second connecting bridge connecting any two adjacent second sensing electrodes. At least one pinnacle is disposed on the first sensing electrode and points to a third direction. Superfluous electric charges on the touch panel are accumulated on the pinnacle. The pinnacle and the second sensing electrode are overlapped and insulated. Therefore, the accumulated electric charges discarge electricity through the pinnacle, and the second sensing electrode produces a current. Real-time discharge of electrostatic is conducted. This is the benefit provided by the present invention.

### BRIEF DESCRIPTION OF THE DRAWINGS

FIG. 1 shows a schematic diagram of a conventional touch panel using the metallic edges connected to ground

FIG. 2 is a schematic diagram of a touch panel according to a first embodiment of the present invention.

FIG. 3 is a schematic diagram of a touch unit in the touch panel as shown in FIG. 2 according to the first embodiment of the present invention.

FIG. 4 is a cross-sectional view of the touch unit as shown in FIG. 3 along an A-A direction.

FIG. 5 is a schematic diagram of a mobile terminal 200 according to the first embodiment of the present invention.

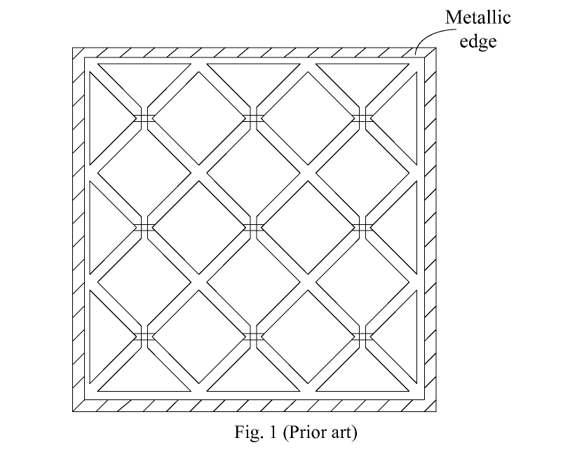

### DETAILED DESCRIPTION OF THE PREFERRED EMBODIMENTS

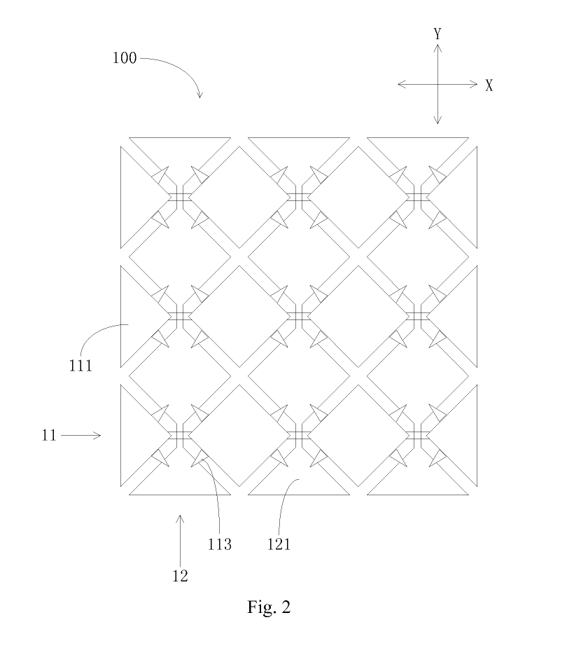

Please refer to FIG. 2. FIG. 2 is a schematic diagram of a touch panel 100 according to a first embodiment of the present invention. The touch panel 100 comprises a plurality of first conductive wires 11 extending along a first direction X and a plurality of second conductive wires 12 extending along a second direction Y. One of the conductive wires is used for inputting a driving signal, and the other is used for receiving a checking signal. So it is possible that a driving electrode Tx is disposed in the first conductive wire 11, and a checking electrode Rx is disposed in the second conductive wire 12. Or, it is possible that a checking electrode Rx is disposed in the first conductive wire 11, and a driving electrode Tx is disposed in the second conductive wire 12. When touch detection conducts, variation of the mutual capacitance on the cross point of the conductive wires is detected, or variation of the self capacitance in each of the conductive wires is detected. The touch point is detected in the way of self-capacitance or mutual capacitance. Provided that the first direction X and the second direction Y form a coordinate system, the position of the touch point can be identified on the coordinate system. An ordinary and standard method is that the first direction X is perpendicular to the second direction Y for detecting capacitance more easily and positioning coordinates more conveniently. If the touch panel 100 is shaped to be other shapes such as a round, an irregular shape, or a curve, the first direction X and the second direction Y may be crossed instead of perpendicular.

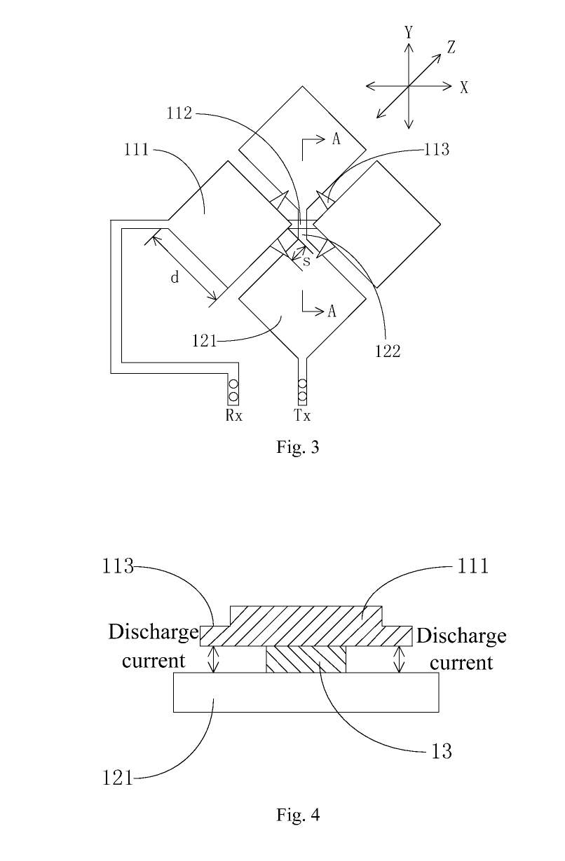

Please refer to FIG. 3. FIG. 3 is a schematic diagram of a touch unit in the touch panel 100 as shown in FIG. 2 according to the first embodiment of the present invention. The touch unit is the repetition structure of the touch panel 100. The first conductive wire 11 comprises a plurality of first sensing electrodes 111 arranged at intervals in the first direction X and a first connecting bridge 112 connecting any two adjacent first sensing electrodes 111. Further, a pinnacle 113 is disposed on the first sensing electrode 111 for discharging electrostatic. The pinnacle 113 points to a third direction Z. The second conductive wire 12 comprises a plurality of second sensing electrodes 121 arranged at intervals in the second direction Y and a second connecting bridge 122 connecting any two adjacent second sensing electrodes 121.

The touch panel 100 is a square touch panel. The first sensing electrode 111 and the second sensing electrode 121 form a triangle at the sides of the touch panel 100; otherwise, the first sensing electrode 111 and the second sensing electrode 121 form a diamond. The first connecting bridge 112 is connected to the vertices of any two adjacent first sensing electrodes 111. The second connecting bridge 122 is connected to the vertices of any two adjacent second sensing electrodes 121. The pinnacle 113 may be a triangular or stripped pinnacle or a peaked pinnacle which is thin on top and thick on bottom. In this embodiment, four pinnacles 113 are disposed on each of the plurality of first sensing electrodes 111. The four pinnacles 113 are disposed on the four sides of the first sensing electrode 111, respectively. Or, two of the four pinnacles 113 are disposed on two of the four sides of the first sensing electrodes 111 corresponding to two sides of the second sensing electrode 121, and the other pinnacles 113 are disposed on the other sides of the second sensing electrode 121. Of course, only one pinnacle 113 or a plurality of pinnacles 113 may be disposed on each of the plurality of first sensing electrodes 111. Or only one pinnacle 113 or a plurality of pinnacles 113 may be disposed on the second sensing electrode 121 in other embodiments.

The first sensing electrode 111, the first connecting bridge 112, the second sensing electrode 121, and the second connecting bridge 122 are fabricated from the same material such as transparent conductive material or indium tin oxide (ITO)/conductive glass. The pinnacle 113 and the first sensing electrode 111 may be fabricated from the same material, and the pinnacle 113 and the first sensing electrode 111 are formed in the same masking process. The pinnacle 113 and the first sensing electrode 111 may be fabricated from different materials, and the pinnacle 113 is conducted and welded on the first sensing electrode 111. The manufacturing process of the touch panel 100 is not limited in the present invention; instead, the manufacturing process of the touch panel 100 varies based on practical conditions. An example is that the first sensing electrode 111, the second sensing electrode 121, and the second connecting bridge 122 are also formed in the same masking process at first, and then the first connecting bridge 112 and the pinnacle 113 are produced and conducted to the first sensing electrode 111 when the pinnacle 113 and the first sensing electrode 111 are fabricated from the same material. The first sensing electrode 111, the second sensing electrode 121, and the second connecting bridge 122 are formed in the same masking process, and a wider area is produced. Since the material can be fully utilized, the cost is reduced.

Seen from the plane, the first sensing electrode 111 and the second sensing electrode 121 are arranged in a zigzag order. The sides of the first sensing electrode 111 and the sides of the second sensing electrode 121 are in parallel. The third direction Z, which the pinnacle 113 points to, is not a specific direction. The third direction Z is particularly different from the first direction X and from the second direction Y. Any direction forming a specific direction with the first direction X and the second direction Y can be regarded as the third direction Z. The third direction Z shown in FIG. 3 merely represents two of the four directions which the four pinnacles 113 point to. The other two directions are disposed opposite. The third direction Z is perpendicular to the sides of the first sensing electrode 111 in this embodiment. Of course, it is possible that the third direction Z is not perpendicular to the sides of the first sensing electrode 111 in other embodiments. The length of the pinnacle 113 is larger than the distance between the first sensing electrode 111 and the second sensing electrode 121. In other words, the pinnacles 113 are overlapped above the second sensing electrode 121.

Please refer to FIG. 4. FIG. 4 is a cross section of the touch unit as shown in FIG. 3 along an A-A direction. The first connecting bridge 112 and the second connecting bridge 122 are overlapped. An insulation layer 13 is inserted between the first connecting bridge 112 and the second connecting bridge 122. The pinnacle 113 and the second sensing electrode 121 are overlapped and insulated.

The process of ESD of the pinnacle 113 is explained. Generally, the touch panel 100 is placed on the surface of the device. The touch panel 100 and other objects easily rub together, producing electricity and transferring electric charges. Once too much electric charges are accumulated on the sensing electrode of the touch panel 100, the accumulated electric charges will produce electrostatic. Because of electrostatic, the touch panel 100 senses touched easily and mistakenly. Then the touch panel 100 gives the baseband chip wrong information, causing a wrong trigger. On the process of sending and receiving signals between two sensing electrodes, differences, i.e., differences of electric levels, often occur due to energy consumption, outer interference, etc. The differences reflect on the amount of electric charges, that is, inconformity of positive and negative electric charges. The inconformity of positive and negative electric charges results in superfluous electric charges. Therefore, ESD is conducted in this embodiment. Specifically, real-time discharge of electric charges from the pinnacle 113 is conducted.

Electric charges are often accumulated on acute portions of a conductor. It means that superfluous positive or negative electric charges tend to accumulated on the pinnacle 113. When the electric charges are accumulated to a certain degree, the magnetic field around the pinnacle 113 amplifies. Accordingly, the air surrounding the pinnacle 113 is ionized, the pinnacle 113 discharges, and the pinnacle 113 and other conductors produce a discharging current. Finally, electric charges release. The pinnacle 113 and the second sensing electrode 121 are overlapped so a longitudinal current is produced between the accumulation of the pinnacle 113 and the second sensing electrode 121. Because the area of the first sensing electrode 111 and the second sensing electrode 121 is larger than the pinnacle 113, the strong current produced by instantly discharging pinnacle 113 will not easily damage the first sensing electrode 111 or the second sensing electrode 121.

Because the first connecting bridge 112 between any two adjacent first sensing electrodes 111 is relatively thinner, superfluous electric charges are often accumulated on the first connecting bridge 112. The first connecting bridge 112 does not comprise an acute portion so it is difficult for the accumulated electric charges to release. So the electric charges on the first connecting bridge 112 have to be transferred to the pinnacle 113. The pinnacle 113 in this embodiment is disposed near the first connecting bridge 112. The distance between the pinnacle 113 and the first connecting bridge 112 is smaller than the distance between the pinnacle 113 and any other vertices of the first sensing electrodes 111. The formula s<d−s is proposed. In this formula, s represents the distance between the pinnacle 113 and the first connecting bridge 112, and d represents the length of the first sensing electrode 111. The first sensing electrode 111 in this embodiment is a special diamond, i.e., a square.

The length d of the sides of the first sensing electrode 111 and second sensing electrode 121 is 3 to 7 mm. The distance s between the pinnacle 113 and the first connecting bridge 112 is 1 to 3 mm while the length d is set to be 5 mm, and the distance s is set to be 1 mm in this embodiment. If the resolution of the touch panel needs to be higher, the length d may be set to be 3 mm and meanwhile, the distance s is set to be 1 mm. If the size of the touch panel is larger, the length d may be 7 mm and meanwhile, the distance s is set to be 3 mm. Of course, the length d may be 2 mm and the distance s may be 0.5 mm, or the length d may be 8 mm and the distance s may be 3.5 mm in other embodiments. The length d and the distance s can be planned based on practical conditions. In other words, the length d and the distance s are not limited here.

In contrast to prior art, the touch panel of the present invention comprises a first conductive wire extending along a first direction and a second first conductive wire extending along a second direction. The first and second conductive wires are overlapped. The first conductive wire comprises a plurality of first sensing electrodes arranged at intervals and a first connecting bridge connecting any two adjacent first sensing electrodes. The second conductive wire comprises a plurality of second sensing electrodes arranged at intervals and a second connecting bridge connecting any two adjacent second sensing electrodes. At least one pinnacle is disposed on the first sensing electrode and points to a third direction. Superfluous electric charges on the touch panel are accumulated on the pinnacle. The pinnacle and the second sensing electrode are overlapped and insulated. Therefore, the accumulated electric charges discarge electricity through the pinnacle, and the second sensing electrode produces a current. Real-time discharge of electrostatic is conducted. This is the benefit provided by the present invention.

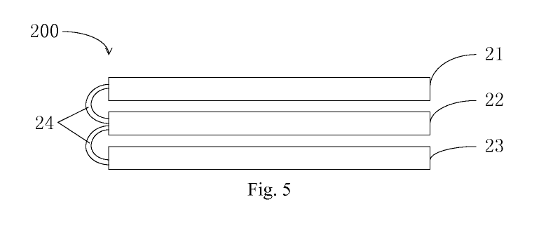

Please refer to FIG. 5. FIG. 5 is a schematic diagram of a mobile terminal 200 according to the first embodiment of the present invention. The mobile terminal 200 comprises a touch panel 21, a display panel 22, and a motherboard 23.

The touch panel 21 has the same structure and functions of the touch panel 100 shown in FIG. 2. The display panel 22 is a thin film transistor liquid crystal display (TFT-LCD). The motherboard 23 is used for control and calculation. The touch panel 21, the display panel 22, and the motherboard 23 are connected with one another with a flexible printed circuit (FPC) 24.

Compared with the conventional technology, real-time electrostatic discharge from the touch panel in the mobile terminal of this embodiment successfully realizes. So it is very hard for the users of the touch panel in the mobile terminal of the embodiment to operation the device incorrectly. In other words, the users of this touch panel will feel it convenient to use, which will increase user experience as well.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A touch panel comprising:
a first conducting wire extending along a first direction, comprising a plurality of first sensing electrodes arranged along the first direction and a plurality of first connecting bridges linking two adjacent first sensing electrodes; and
a second conducting wire extending along a second direction and crossing the first conducting wire, comprising a plurality of second sensing electrodes arranged along the second direction and a plurality of second connecting bridges linking two adjacent second sensing electrodes;
wherein each first sensing electrode comprises one or more pinnacles extending toward a third direction, and each pinnacle overlaps and is spaced apart from the second sensing electrode;
in a top view, the plurality of first sensing electrode and the plurality of second sensing electrode are arranged in a zigzag order, the first connecting bridge overlaps the second connecting bridge;
the first direction is perpendicular to the second direction.

2. The touch panel of claim 1, wherein each first sensing electrode and each second sensing electrode are shaped as diamonds, and edges of the first sensing electrode are parallel to corresponding edges of the second sensing electrode.

3. A touch panel comprising:
a first conducting wire extending along a first direction, comprising a plurality of first sensing electrodes arranged along the first direction and a plurality of first connecting bridges linking two adjacent first sensing electrodes; and
a second conducting wire extending along a second direction and crossing the first conducting wire, comprising a plurality of second sensing electrodes arranged along the second direction and a plurality of second connecting bridges linking two adjacent second sensing electrodes;
wherein each first sensing electrode comprises one or more pinnacles extending toward a third direction, and each pinnacle overlaps and is spaced apart from the second sensing electrode.

4. The touch panel of claim 3, wherein in a top view, the plurality of first sensing electrode and the plurality of second sensing electrode are arranged in a zigzag order, the first connecting bridge overlaps the second connecting bridge.

5. The touch panel of claim 4, wherein each first sensing electrode and each second sensing electrode are shaped as diamonds, and edges of the first sensing electrode are parallel to corresponding edges of the second sensing electrode.

6. The touch panel of claim 5, wherein a length of the pinnacle is longer than an interval between the first sensing electrode and the second sensing electrode.

7. The touch panel of claim 5 further comprising an insulting layer sandwiched between the plurality of first connecting bridges and the plurality of second connecting bridges.

8. The touch panel of claim 5 wherein each first sensing electrode comprises four pinnacles disposed on four edges of the first sensing electrode, respectively.

9. The touch panel of claim 8, wherein the first connecting bridge links two vertices of the two adjacent first sensing electrodes, and a distance from the pinnacle to the first connecting bridge linking the first sensing electrode which comprises the pinnacle is less than a distance between the pinnacle and other corners of the first sensing electrode.

10. The touch panel of claim 9, wherein the edges of the first sensing electrode and the second sensing electrode are set to 3 mm˜7 mm, and a distance between the pinnacle and the first connecting bridge is 1 mm˜3 mm.

11. The touch panel of claim 3, wherein the first direction is perpendicular to the second direction.

12. A mobile terminal comprising a touch panel, the touch panel comprising:
a first conducting wire extending along a first direction, comprising a plurality of first sensing electrodes arranged along the first direction and a plurality of first connecting bridges linking two adjacent first sensing electrodes; and
a second conducting wire extending along a second direction and crossing the first conducting wire, comprising a plurality of second sensing electrodes arranged along the second direction and a plurality of second connecting bridges linking two adjacent second sensing electrodes;
wherein each first sensing electrode comprises one or more pinnacles extending toward a third direction, and each pinnacle overlaps and is spaced apart from the second sensing electrode.

13. The mobile terminal of claim 12, wherein in a top view, the plurality of first sensing electrode and the plurality of second sensing electrode are arranged in a zigzag order, the first connecting bridge overlaps the second connecting bridge.

14. The mobile terminal of claim 13, wherein each first sensing electrode and each second sensing electrode are shaped as diamonds, and edges of the first sensing electrode are parallel to corresponding edges of the second sensing electrode.

15. The mobile terminal of claim 14, wherein a length of the pinnacle is longer than an interval between the first sensing electrode and the second sensing electrode.

16. The mobile terminal of claim 14 wherein the touch panel further comprises an insulting layer sandwiched between the plurality of first connecting bridges and the plurality of second connecting bridges.

17. The mobile terminal of claim 14 wherein each first sensing electrode comprises four pinnacles disposed on four edges of the first sensing electrode, respectively.

18. The mobile terminal of claim 17, wherein the first connecting bridge links two vertices of the two adjacent first sensing electrodes, and a distance from the pinnacle to the first connecting bridge linking the first sensing electrode which comprises the pinnacle is less than a distance between the pinnacle and other corners of the first sensing electrode.

19. The mobile terminal of claim 18, wherein the edges of the first sensing electrode and the second sensing electrode are set to 3 mm˜7 mm, and a distance between the pinnacle and the first connecting bridge is 1 mm˜3 mm.

20. The mobile terminal of claim 12, wherein the first direction is perpendicular to the second direction.
